(19) United States
(12) Patent Application Publication
(10) Pub. No.: US 2004/0158582 A1
(43) Pub. Date: Aug. 12, 2004

(54) Method and apparatus for synchronously transferring data from a local storage medium to a remote storage medium, and method and system for managing transfer of data from a source storage medium to a repository storage medium

(76) Inventors: Shuichi Takagi, Kawasaki-shi (JP); Craig A. Willis, Englewood, CO (US); Robert L. Cordingley, Lafayette, CO (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/699,102

(22) Filed: Oct. 31, 2003

Related U.S. Application Data
(60) Provisional application No. 60/446,929, filed on Feb. 11, 2003.

(51) Int. Cl. G06F 17/00

(52) U.S. Cl. 707/104.1

(57) ABSTRACT

A method for synchronously transferring an amount of local data from a local data storage medium to a remote data storage medium via a communications link having an available bandwidth is provided. The method includes: evaluating local user conditions associated with transfer of the local data; based on the available bandwidth and the amount of local data, approximating a transfer time for the local data; based on the approximated transfer time, the local user conditions, and a status of the local processor, selecting a time to transmit the local data to the remote data storage medium; and automatically arranging transfer of the local data to the remote data storage medium via the communications link at the selected time.

### STATEMENT OF RELATED APPLICATION

This application claims the benefit of priority to U.S. provisional patent application No. 60/446,929, filed Feb. 11, 2003, incorporated in its entirety herein by reference.

### BACKGROUND OF THE INVENTION

1. Field of the Invention

Aspects of this invention relate generally to data transfer and storage, and more particularly to a method and apparatus for synchronously transferring local data to an online storage medium, and to a method and system for managing transfer of data and user authorization.

2. Description of Related Art

Local home- or office-based personal computer (“PC”) systems may share data with remote computers in a variety of manners, via a variety of networks. An information service such as the World Wide Web, for example, uses standard protocols to allow computer users with a browser application to transfer data to and from computer networks such as the Internet.

Client-server architectures, such as those in which computer programs are configured to cause PC clients to request services from Internet-based, or online, service providers, have fueled availability of online services to PC users. Online service providers @Backup® and Connected™, for example, use client-server techniques to implement online data storage services, specifically PC backup services, in which desired data from PCs is periodically transferred to a central server or other remote data storage medium, and managed by the online service providers.

The typical local PC client, however, has a single processor under independent control, and a limited-bandwidth communication link to any remote data storage medium. As such, the local PC may be unable to concurrently perform multiple processing-intensive tasks, such as transferring large data files and running unrelated user applications, and/or data transfer may be slow, reducing the convenience of an online data storage service for a PC user. Even when data transfer times are lowered using well-known techniques, a user may have to wait to use his PC until data transfer is complete.

Online service providers may also be concerned with inconveniences in providing data storage services to PC users, including the possibility of liability based on a PC user's transfer, and illegal sharing, of data stored by the service provider that is protected by the intellectual property rights of others.

There are therefore needs for methods, computer programs, apparatuses and systems to manage data transfer and storage to reduce the impact of various design and operational inefficiencies of PCs, communication links and data storage services.

### SUMMARY

According to one aspect of the present invention, a method for synchronously transferring an amount of local data from a local data storage medium to a remote data storage medium via a communications link having an available bandwidth is provided. The method may be implemented by a computer program, stored on a computer-readable medium. The local data storage medium is associated with a local computer system having a local processor sequentially responsive to a plurality of local computer programs, and the remote data storage medium is associated with a remote computer system non-redundant of the local computer system and having a remote processor. The method includes: evaluating local user conditions associated with transfer of the local data; based on the available bandwidth and the amount of local data, approximating a transfer time for the local data; based on the approximated transfer time, the local user conditions, and a status of the local processor, selecting a time to transmit the local data to the remote data storage medium; and automatically arranging transfer of the local data to the remote data storage medium via the communications link at the selected time.

Transfer of the local data may be interrupted at any time, based on the status on the local processor. The status of the local processor may be inferred from the status of a display device (e.g., the status of a screen saver) or memory, the processor utilization, and/or a time since a last interactive use of the local computer system. Transfer of the local data may automatically resume.

According to another aspect of the present invention, an apparatus for synchronously transferring an amount of local data from a local data storage medium to a remote data storage medium via a communications link having an available bandwidth is provided. The local data storage medium is associated with a local computer system having a local processor sequentially responsive to a plurality of local computer programs, and the remote data storage medium is associated with a remote computer system non-redundant of the local computer system and having a remote processor. The apparatus includes a computer-readable storage medium, and a processor responsive to the computer-readable storage medium and to a computer program. When the computer is loaded into the processor, it is operative to perform a method. The method includes: evaluating local user conditions associated with transfer of the local data; based on the available bandwidth and the amount of local data, approximating a transfer time for the local data; based on the approximated transfer time, the local user conditions, and a status of the local processor, selecting a time to transmit the local data to the remote data storage medium; and automatically arranging transfer of the local data to the remote data storage medium via the communications link at the selected time.

According to a further aspect of the present invention, a method for managing transfer of data from a source data storage medium associated with a source computer system to a repository data storage medium associated with a repository computer system is provided. The source computer system is arranged to receive online requests for the data from a local computer system, and the repository computer system arranged to provide an online data storage service for the local computer system. The method includes: receiving a request from the local computer system for transfer of the data from the source data storage medium to the repository data storage medium; based on the request, determining an authorization status of the local computer system to access the data, the authorization status based on whether an operator of the local computer system is licensed under predetermined intellectual property rights associated with the data; and based on the authorization status, arranging for transfer of the data from the source data storage medium to the repository data storage medium. The continued accessibility of the local computer system to the data in the repository data storage medium is based on the authorization status of the local computer system.

According to a still further aspect of the present invention, a system for managing transfer of data from a source data storage medium to a repository data storage medium is provided. The repository data storage medium is arranged to provide an online data storage service for a local computer system. The system includes a network communications interface. A source is coupled to the network communications interface, for receiving a request from the local computer system for transfer of the data from the source data storage medium to the repository data storage medium, and for arranging for determination of an authorization status of the local computer system to access the data. The authorization status is based on whether an operator of the local computer system is licensed under predetermined intellectual property rights associated with the data. An information processing system processes the request received by the source, and arranged for transfer of the data from the source data storage medium to the repository data storage medium. The continued accessibility of the local computer system to the data in the repository data storage medium is based on the authorization status of the local computer system.

### BRIEF DESCRIPTION OF THE DRAWINGS

FIG. 1 is a diagram illustrating an architecture for managing data transfer and storage, adapted for use by local computer systems and/or online service providers, in accordance with aspects of the present invention.

FIG. 2 is a flowchart of a method for synchronously transferring data from a local data storage medium to an online remote data storage medium, in accordance with an aspect of the present invention.

FIG. 3 is a flowchart of a method for managing data transfer from a source data storage medium to an online repository data storage medium at the request of a local computer system, in accordance with another aspect of the present invention.

### DETAILED DESCRIPTION

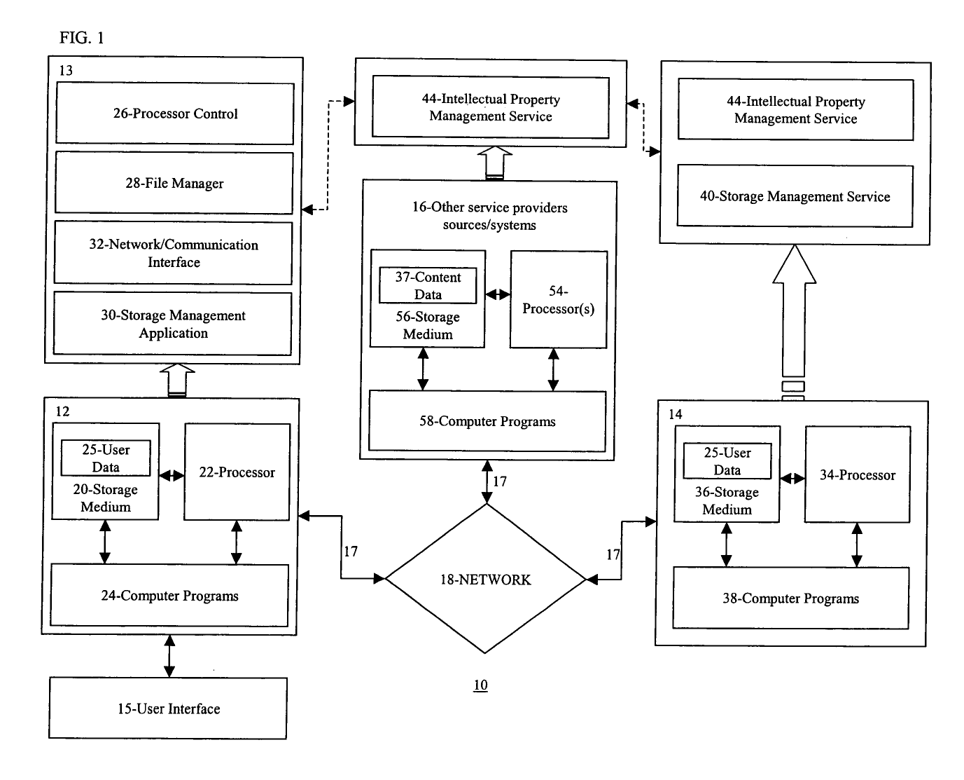

Turning now to the drawings, wherein like numerals designate like components, FIG. 1 illustrates an architecture 10 for managing data transfer and storage in accordance with various aspects of the present invention. Conceptually, architecture 10 includes a local computer system 12, which is coupled to a user interface 15, such as a keyboard, mouse, display, and/or other user interface(s), and service provider computer systems 14 and 16, arranged to communicate and/or exchange data with local computer system 12 across network 18 via communications links 17. For exemplary purposes, local computer system 12 is a personal computer (“PC”), which may be a single-user or multiple-user multi-programming sequential processing system, service provider computer systems 14, 16 are servers, communications links 17 are modems, and network 18 is the Internet. Connections to network 18 via communications links 17 are generally low-bandwidth and high-latency, typically between 56 kbps and 1 Mbps.

Architecture 10, however, will be understood to include any type or size of existing or future, public or private, wired or wireless inter- or intra-computer infrastructure or technology, including but not limited to a fiber-optic network, a coaxial cable network, a hybrid network, a satellite network, cellular network, a broadcast network, or a copper wire network, or any combination thereof, as well as any type of communication protocols and all layers thereof. Architecture 10 may also include layers of other computers or networks, including but not limited to local area networks, wide area networks and firewall networks.

Internal arrangements of local computer system 12 are well known, and may include items such as a computer-readable storage medium 20, a processor 22, and computer programs 24. Other items (not shown) may include at least one disk controller, and a modem or other network adapter, operational and/or in communication with other elements of local computer system 12 in accordance with well known methods and techniques. Computer-readable storage medium 20, responsive to processor 22 and computer programs 24, includes one or more logical or physical, internal or external, primary or secondary storage areas capable of storing data, and may be any device or technology, now known or later developed, including but not limited to a physical memory, virtual memory, an internal or external hard disk drive (e.g., a magnetic disk), a random access memory, a videocassette recorder tape, all types of compact disks and digital videodisks, a magnetic tape, a home router, or any other electronic storage device. As is well-known, for most PCs, the amount of main memory required to execute and utilize multiple computer programs 24 exceeds available local physical memory. Modem operating systems, therefore, implement virtual memory, which allows the combined size of a computer program, data and stack to exceed the amount of available physical memory. An operating system keeps parts of computer programs currently being used in main memory, and the remainder in secondary storage, such as a disk. Accessing data from secondary storage is significantly slower than accessing data in a main memory.

User data 25, among other things, is stored on computer-readable storage medium 20. User data 25 includes any user-generated digital content, such as content from: imaging devices like cameras and recorders; audio players or recorders; computers and computer programs; personal communication devices; and any other electronic data. User data 25 may further include content such as video, audio or publication material, provided by sources such as service provider computer system 16, which may be operated by a television network or station, a studio, an Internet broadcaster or service provider, a publisher, a cable operator, a satellite operator or the like. Still further, user data 25 includes logical arrangements or other designations for data, such as file names, directories, file types, application types, or other data designations. User data 25 may be ‘raw’ data, data arranged for formatting in accordance with any predetermined media format, or data already formatted in accordance with any predetermined media format. Configuration data (not shown), which represents user- and system-defined configuration settings, such as communication settings, network settings, and the like, may also be stored on computer-readable storage medium 20, for example, in a database (not shown).

Processor 22, responsive to computer-readable storage medium 20 and computer programs 24, is preferably a single central processing unit, which executes instructions sequentially and is under the control of local computer 12. Computer programs 24 are generally organized into functional components. Block diagram 13 illustrates certain aspects of the functional arrangement of computer programs 24 in more detail.

Processor control function 26, which may include any suitable operating system (for example, Windows™), provides an application program interface that controls the execution of computer programs 24, or components thereof, within local computer system 12. A suitable processor control function 26 may be selected or implemented by one skilled in the art.

File manager function 32 controls storage of user data 25, and other files stored in computer-readable storage medium 20, and manages requests from applications, such as storage management application 30 (discussed further below), for access to the files. A suitable file manager function 32 may be selected or implemented by one skilled in the art.

Network/communication interface function 32, which may support, for example, a Web browser, modem, streaming media player, and/or other network connection support device(s), is responsive to, and responsible for, mechanics of communication between storage management application 30 (discussed further below) and storage management application 40 (also discussed further below), via communications link 17 and network 18, and may be selected or implemented in accordance with well-known methods and protocols by one skilled in the art.

Storage management application 30 represents the client component of a computer program or user application, which, when executed, is capable of implementing aspects of the present invention relating to online data transfer and storage at client computer 12. Storage management application 30 is preferably adapted to respond to a server component of storage management application 40 (discussed further below) located at a remote computer system, such as service provider computer system 14 (also discussed further below), via network/communication interface function 32. Both client and server components of storage management application 30, 40 may be implemented according to well-known software engineering practices for component-based software development. Other user applications (not shown) may also reside on computer system 12. Storage management application 30 also preferably makes use of standard operating system facilities for device I/O, memory management and process management, which reside on computer system 12. Storage management application 30, or parts thereof, may be stored on a secondary storage medium, such as a local hard disk.

Service provider computer systems 14, 16, which are preferably servers, but may be different types of computer systems, include the same basic internal components and arrangements thereof as local computer system 12, including, respectively, processors 34, 54 computer-readable storage media 36, 56 and computer programs 38, 58. As shown, user data 25 is also stored on computer-readable storage medium 36. Service provider computer systems 14, 16 may in fact be multiple servers, and may further include other well-known elements (not shown), configured in well-known manners, and using well-known techniques, such as: an amount of physical memory; multiple internal secondary storage devices; multiple disk controllers; at least one high-speed network adapter; network attached storage (“NAS”); or a hierarchical storage management (“HSM”) system. Systems 14, 16 may still further include human-device interfaces, or administrators may access them using network 18 or other adapters. Connection to the Internet is typically high-bandwidth and low-latency (for example, 1 Mbps to 700 Mbps), and connection to a local server network (not the Internet) is also typically high-bandwidth and low-latency (100 Mbps to 1 Gbps).

Storage management application 40 represents the server component of a computer program which, when executed, is capable of implementing aspects of the present invention relating to online data transfer and storage at (one or more) service provider computer system(s) 14. Storage management application 40, which is preferably stored in secondary storage (on storage medium 56, for example), and which may be simultaneously running on multiple clustered computers, is adapted to respond to client component of storage management application 30 located at a local computer system 12, via network 18, a network/communication interface function (not shown; analogous to network/communication interface function 32), and/or communications link 17 in accordance with well-known methods and protocols. Storage management application 40 is preferably responsible for accepting connections/communications from client storage management application 30, processing incoming protocol commands, and acting on the protocol commands.

Intellectual property management service 44 represents a component of a computer program which, when executed, is capable of implementing aspects of the present invention relating to transfer of data, which may be protected by intellectual property rights, to authorized users (discussed further below). Intellectual property management service 44 may be implemented as a client-server application, on any client-server architecture. As shown, a client component of intellectual property management service 44 is located at service provider computer system 16, and a server component of intellectual property management service 44 is located at service provider computer system 14.

During normal operation in accordance with aspects of the present invention, an operator, or user (not shown), of local computer system 12 selects, via user interface 15, user data 25 for transfer to online service provider computer system 14. The user is preferably presented with a logical representation of a secondary storage device and/or file system, and selects desired user data 24, such as files, be transferred to online service provider computer system 14. In accordance with well-known methods and techniques, information identifying individual files based on operating system and file system procedures is stored in a configuration database on the secondary storage device.

The user may specify conditions associated with selection of user data 25, such as, among other conditions: where the data is located; file extensions associated with the data; times, or events, which would trigger transfer of the data; or any combination thereof. For example, the user may request that user data 25 having file extensions such as .DOC or .JPG be transferred immediately, while user data 25 have file extensions such as .MPG or .RM be transferred overnight. In another example, the user may request that user data 25 be transferred only when a specified amount of bandwidth is available at communications link 17, such as when the user has a continuous Internet connection available.

In addition, or alternatively, to specifying timing of data transfer, the user may allow storage management application 30 to automatically coordinate timing and performance of data transfer, to minimize data transfer times and maximize availability of computer and network resources associated with local computer system 12 to the user.

According to one aspect of the present invention, when the user requests that storage management application 30 automatically coordinate timing and performance of transfer of specified user data 25, storage management application 30 approximates a transfer time for user data 25, based on bandwidth available at communications link 17, and on particular characteristics of the specified user data 25, such as file size in bytes and/or file type. A sample chart showing approximate transfer times for various user data 25 and available bandwidths is attached as Appendix A.

Storage management application preferably manages synchronous transfer of user data 25 requiring substantial upload time during periods of reduced user activity at local computer system 12, which also meet other specified user conditions. Periods of reduced user activity at local computer system 12 may be determined by monitoring a status of processor 22, and may serve as triggers for beginning data transfer. The status of processor 22 may be monitored directly, or may be inferred by monitoring the status of other programs or devices associated with local computer system 12. For example, periods of reduced user/processor activity may be inferred from the following conditions, among others: when one or more user interfaces 15 is in stand-by mode, such as when a screen-saver is activated on a display; when a memory, such as storage medium 20, has not been accessed for a predetermined period of time; or when a predetermined period of time has passed since a last interactive use (e.g., last receipt of user input) of computer system 12. Techniques exist in modem operating systems to monitor human-device interface activity through a device's input/output subsystem.

Execution of storage management application 30 may entail loading storage management application 30 into a main memory, reading the configuration data (not shown) from a database (not shown), and connecting to one or more remote service provider computer systems, such as service provider computer system 14, via a connection to network 18, for coordination of execution of storage management service 40. Storage management application may further be responsible for initiating user-authentication procedures, reading/writing user data 25 using a local secondary storage device, such as storage medium 20, sending/receiving data using a network adapter device/network interface 32, compressing/decompressing, and/or encrypting/decrypting user data 25.

Execution of storage management application 40 may entail loading storage management application 40 into a main memory, reading configuration data (not shown, analogous to configuration data associated with local computer system 12), and, using standard operating system network programming techniques, ‘listening’ for connections from client storage management application 30 and/or local computer system 12 on specific ports (not shown). Storage management application 40 may further be responsible for processing protocol commands from storage management application 30 and/or local computer system 12, and responding to the protocol commands according to the defined protocol.

Transfer of user data 25 from local computer system 12 to service provider computer system 14 may occur via any suitable user-level network protocol that defines a set of commands and responses used for communication between storage management application 30 and/or local computer system 12, and storage management application 40 and/or service provider computer system 14. Network bandwidth use may be maximized using TCP high-performance extensions. In addition, a software development kit may be provided at local computer system 12, or accessed via service provider computer system 14 or 16, for programmatic access to remote data, security, authorization and authentication resources.

To support the transfer of data within restricted environments, such as corporate networks that are protected by firewalls and/or don't support the use of standard protocols such as file transfer protocol or other custom user-level protocols, hypertext transfer protocol (HTTP) tunneling may be employed, to ensure protocol support in restricted network environments.

The following series of steps may be performed in order to transfer user data 25 from local computer system 12 to service provider computer system 14: local computer system 12 establishes a connection to service provider computer system 14 via communications links 17 and/or network 18; local computer system 12 reads user data 25 from a secondary storage device associated with local computer system 12; local computer system 12 compresses and/or encrypts user data 25; local computer system 12 writes user data 25 to a network adapter; service provider computer system 14 reads user data 25 from the network adapter; service provider computer system 14 decrypts and/or decompresses user data 25; and service provider computer system 14 writes user data 25 to a local or network storage device.

Procedures further defining reading of user data 25 from local computer system 12 are well known, and may entail reading from a local storage subsystem (not shown) using standard operating system drivers, application program interfaces, and programming techniques. To ensure successful file transfer between local computer system 12 and service provider computer system 14, integrity checking is employed. A user-level application protocol is preferably employed, on top of the standard TCP/IP network protocol, which defines a standard integrity-checking mechanism to ensure the transfer of individual data packets over a network, although a low-level network protocol may also be employed. Storage management application 30 provides a final integrity check to ensure successful transmission—and reassembly on service provider computer system 14—of user data 25. An MD5 file checksum may be employed for integrity checking, implemented in a variety of well-known manners, using standard algorithms, although other checksums may be used.

Since user data 25 may include large files, and main memory is limited, standard programming techniques may be employed to read small sequential blocks of user data 25 into main memory for processing. Since the network connection is low-bandwidth and high latency, user data 25 may be compressed prior to transfer. Compression, however, need only be implemented if the time or resources saved from compression are greater than the time or resources required to perform the compression.

When blocks of user data 25 are in main memory, cryptographic techniques may be applied to encrypt user data 25 before transfer over network 18. Any suitable encryption algorithm or module may be used, such algorithms and models being well-known and widely available.

Prior to transmission of user data 25, local computer system 12 indicates to service provider computer system 14 that local computer system 12 is sending user data 25, and local computer system 12 writes user data 25 to a network adapter (not shown) associated with network interface 32. A file checksum is written to network interface 32 using well-known methods and techniques. Standard operating system APIs and device drivers are preferably employed to send/receive data using a network adapter/network interface 32. The file checksum is stored on service provider computer system 14 until transfer of user data 25 is complete.

Upon receiving specified user data 25, service provider computer system 14 reads user data 25 from a network subsystem (not shown) using standard network programming techniques, and writes user data 25 to local or network storage, such as storage medium 56. Procedures further defining reading of user data 25 from the network subsystem may include reading a block of user data 25 into main memory, and applying the required cryptographic technique to decrypt the block of user data 25 while in main memory. If necessary, the data block may be decompressed, to return user data 25 to its original state. After all blocks of user data 25 have been received by service provider computer system 14, another file checksum is calculated, and it is verified that the calculated checksum matches the file checksum sent by local computer system 12.

According to another aspect of the present invention, when user data 25 is being transferred and the triggers that caused initiation of data transfer change (for example, the user logs in or launches another application, cancels the transfer, or the network or system may be disrupted), storage management application 30 arranges for interruption of transfer of user data 25. Interruption may occur at any time.

Once user data 25 has been successfully transferred to service provider computer system 14 (for example, a checksum verifies that a particular block of data was successfully received), there is no need to re-transfer the data, unless the data has been modified since it was transferred. Storage management application 30 preferably arranges for storage of the state of the data transfer in a memory, such as a buffer or RAM, and resumes data transfer during periods of reduced user activity at local computer system 12, which also meet other specified user conditions. The user is preferably prevented from modifying user data 25 being transferred until the transfer is complete, although well-known methods and techniques may be adapted to allow the user to modify user data 25 during data transfer under certain circumstances. When transfer of user data 25 is resumed after interruption, local computer system 12 again sends a checksum to service provider computer system 14, using the defined protocol. The checksum is compared with the existing checksum for the specified user data 25. If the two checksums match, local computer system 12 requests the size of the existing file of user data 25 on service provider computer system 14, and local computer system 12 may begin transferring data to service provider computer system 14 based on an offset of the size of the file of user data 25 stored on service provider computer system 14. For example, if local computer system 12 sent 1 MB of a 2 MB file of user data 25, then was interrupted, upon resuming transfer, local computer system 12 would send only the second 1 MB of data, as the first 1 MB of data was already stored on service provider computer system 14.

After user data 25 is successfully transferred from local computer system 12 to online service provider computer system 14, it is contemplated that service provider system 14 may provide the user of local computer system 12 with access to user data 25 stored on storage medium 36 for purposes of displaying, sharing and otherwise using user data 25, in accordance with well-known methods, techniques, and business practices.

The operator of service provider computer system 14 may be concerned that certain user data 25 is protected by intellectual property rights of third parties, such as content data 37, and may seek to mitigate liability associated with the user of local computer system 12 sharing certain types of user data 25 located on storage medium 36. It is well-known that online markets allow a user to purchase or license copyrighted digital assets using secure network connections. Typically, users select items for purchase/license, enter relevant payment information (credit card number, for example), and execute the transaction via an online service, such as a service operated by service provider computer system 16 (which may be, for example a large entertainment or content provider, or proxy thereof).

According to a further aspect of the present invention, when the user of local computer system 12 selects data, such as user data 25, or source data 37, originating from source service provider computer system 16 for transfer to service provider computer system 14, or for sharing therefrom, intellectual property management service function 44 determines whether the user of local computer system 12 is authorized to use the selected data. Similar to processes for transferring user data 25 from local computer system 12 to service provider computer system 14, local computer system 12 may submit, via storage management application 30, an asset access request, and asset access information, including a protocol command, relating to transfer of the selected data. Service provider computer system 14 and/or service provider computer system 16 receives the protocol command, interprets the asset access information, and re-composes the original asset access request. The request may then be acted on by source service provider computer system 16, which determines whether the user is authorized to download and/or share the selected data.

The authorization status of the user is preferably based on whether the user has taken a license under applicable intellectual property rights associated with the data from applicable holders of such intellectual property rights, such as source computer service provider 16. Source service provider computer system 16 may provide information regarding authorization status of the user to the user directly, or to service provider computer system 14, via signaling implemented in accordance with well-known methods and techniques. It will be understood that such signaling may be embedded in, or external from, the data to be transferred. For example, the user may be re-directed to a web page, or sent a validation email, with instructions on how to download the purchased/licensed digital assets. Instructions may include use of a username/password, a hidden key, or other instructions or access techniques. The download is generally in the form of a universal resource locator (URL), interpretable by most any computer program.

If it is determined that the user is not authorized to transfer or share the data in the requested manner, intellectual property management service function 44 preferably automatically offers to license the user and collect a fee or other consideration in exchange for the license. Intellectual property management service function may make continued accessibility to protected data stored on data storage medium 36 conditioned upon the authorization status of the user, which may be dynamic. Thus, a solution is provided for moving source content directly to an online storage area, avoiding lengthy transfer times for PCs, while maintaining control over unauthorized access to the content.

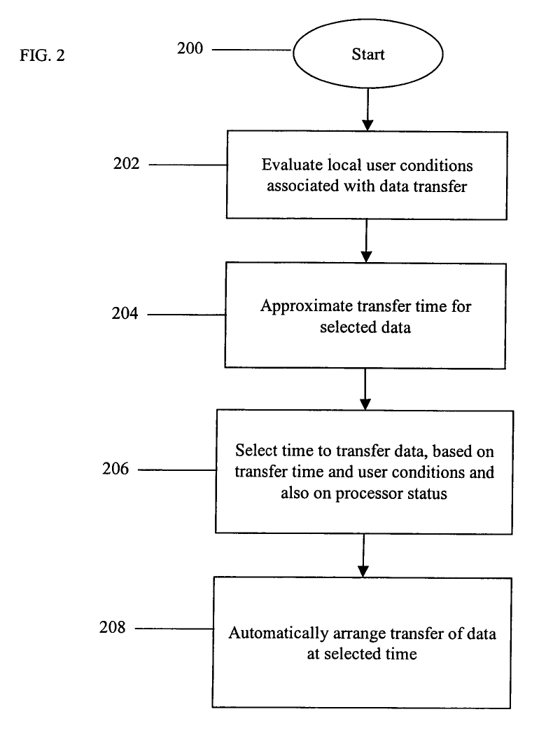

FIG. 2 is a flowchart of a method, which may be implemented by architecture 10, for synchronously transferring selected local data 25 from a local data storage medium, such as storage medium 20 associated with local computer system 12, via a communications link, such as network/communication interface function 32, communications link 17 and/or network 18, to a remote data storage medium, such as storage medium 36, in accordance with an aspect of the present invention. The method starts at block 200 and continues at block 202, where local user conditions associated with transfer of the local data are evaluated. Local user conditions may include, but are not limited to, logical arrangements or other designations of data, such as file names, directories, file types, application types, dates or any other data designations, as well as conditions relating to timing or triggering events for transfer of the data. At block 204, a transfer time for the local data is approximated, based on the available bandwidth of the communications link, and the local data to be transferred. Based on the approximated transfer time, the local user conditions, and the status of a local processor, such as processor 22, a time to transmit the data is selected at block 206. The time selected may be, for example, when the local processor is idle, or during periods of reduced processor activity. The status of the local processor may be determined by directly monitoring the processor, or may be inferred by monitoring the status of other programs or devices associated with local computer system 12.

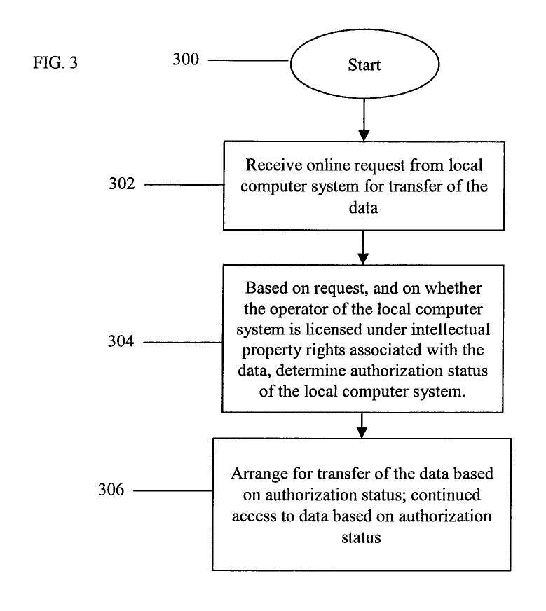

In accordance with another aspect of the present invention, FIG. 3 is a flowchart of a method for managing transfer of data, such as content data 37, from a source data storage medium, such as storage medium 56 associated with a source computer system, such as service provider computer system 16, to a repository data storage medium, such as storage medium 36 associated with a repository computer system, such as service provider computer system 14. The source computer system is arranged to receive online requests for the data from a local computer system, such as local computer system 12, and the repository computer system is arranged to provide an online data storage service for the local computer system. The method starts at block 300, and continues at block 302, where a request is received from the local computer system for transfer of the data from the source computer system to the repository computer system. The local computer system may send the request to the source computer system directly, or indirectly via the repository computer system. At block 204, the authorization status of the local computer system to access the data is determined, based on whether an operator of the local computer system is licensed under predetermined intellectual property rights associated with the data. A transfer of the data from the source data storage medium to the repository data storage medium is arranged at block 304, based on the authorization status of the local computer system, and the local computer system's continued accessibility to the data in the repository storage medium is also based on an authorization status. If it is determined that the operator of the local computer system is not authorized to transfer or share the data in the requested manner, the operator may be automatically licensed by in exchange for a fee or other consideration. Thus, a solution is provided for moving source content directly from one online service provider to another online service provider, avoiding lengthy transfer times of PCs, while maintaining control over unauthorized access to the content.

Aspects of the present invention have been described as being implemented using a client-server architecture. When loaded into a processor, such as processors 22, 34 or 54, computer programs 24, 38 and 58 are operative to implement various aspects of the present invention. It will be appreciated, however, that aspects of the present invention are not limited to any specific embodiments of computer programs or signal processing methods. For example, one or more processors packaged together or with other elements of architecture 10 may implement functions of storage management applications 30, 40 and intellectual property management service 44 in a variety of ways. In one example, both client and server components may be associated with the same computer system, or server-server operations may occur. It will also be appreciated that computer programs 24, 38 and 58 may be any stored instructions, in one or more parts (stored, for example, on storage media 20, 36 or 56, or another internal or external storage medium such as a read-only-memory or a random-access memory) include firmware or hardware, and may be used or implemented by one or more elements, including one or more processors, to implement functions provided by architecture 10.

Moreover, although specific functional elements and arrangements thereof have been described with respect to local computer system 12 and service provider computer systems 14 and 16, it is contemplated that the systems and methods herein may be implemented in a variety of ways. For example, functional elements may be packaged together or individually, or may be implemented by fewer, more or different devices, and may be either integrated within other products, or adapted to work with other products externally. When one element is indicated as being responsive to another element, the elements may be directly or indirectly coupled.

It will furthermore be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

Upload time comparison chart

| MPEG 1Video | Data Capacity | MPEG 2 Video |
|---|---|---|
| 60 min | 0.50 GB | 17 min |
| 120 min | 1.00 GB | 34 min |
| 180 min | 1.50 GB | 51 min |
| 240 min | 2.00 GB | 69 min |
| 420 min | 3.50 GB | 120 min |

| | Net Upload Speed | Upload Time for 1 GB | Upload Time for 2 GB | Upload Time for 2 GB |
|---|---|---|---|---|
| | (13% overhead and | (2 hours MPEG 1 or | (4 hours MPEG 1 or | (7 hours MPEG 1 or 2 |
| Upload Speed | 1 byte = 8 bits) | 34 min MPEG 2) | 69 min MPEG 2) | hours MPEG 2) |
| 125 kbps | 13.83 kByteps | 20.09 hours | 40.18 hours | 60.27 hours |
| 250 kbps | 27.65 kByteps | 10.04 hours | 20.09 hours | 30.13 hours |
| 512 kbps | 56.64 kByteps | 4.90 hours | 9.81 hours | 14.71 hours |
| 1,000 kbps | 110.62 kByteps | 2.51 hours | 5.02 hours | 7.53 hours |
| 2,000 kbps | 221.24 kByteps | 1.26 hours | 2.51 hours | 3.77 hours |

Download/Upload Comparison Chart

One GB file download/upload comparison for various services and transfer rates. Rates are based on current service offerings by providers (e.g. Qwest) as well as information from dslreports.com.

| | | | | | | | 1 GB File |
|---|---|---|---|---|---|---|---|
| | | | | Actual | Actual | 1 GB File | Upstream |
| | | Downstream | Upstream | Downstream | Upstream | Down-stream | Transfer |
| Type | Description | (bps) | (bps) | (Bps) | (Bps) | Transfer (Hr) | (Hr) |
| ADSL | Mid-range, consumer | 256,000 | 90,000 | 27,840 | 9,788 | 10.7 | 30.5 |
| ADSL | Mid-range, consumer | 258,000 | 128,000 | 27,840 | 13,920 | 10.7 | 21.4 |
| ISDN | Typical, consumer | 128,000 | 128,000 | 16,000 | 16,000 | 18.6 | 18.6 |
| ADSL | High-end, consumer | 640,000 | 256,000 | 69,600 | 27,840 | 4.3 | 10.7 |
| | Low-end, small | | | | | | |
| ADSL | business | 640,000 | 272,000 | 69,600 | 29,580 | 4.3 | 10.1 |
| | Mid-range, small | | | | | | |
| ADSL | business | 640,000 | 644,000 | 69,600 | 59,160 | 4.3 | 5.0 |
| | High-end, small | | | | | | |
| ADSL | business | 960,000 | 816,000 | 104,400 | 88,740 | 2.9 | 3.4 |
| ADSL | Enterprise | 1,200,000 | 1,100,000 | 130,500 | 119,625 | 2.3 | 2.5 |
| ADSL | Enterprise | 4,400,000 | 1,100,000 | 478,500 | 119,625 | 0.6 | 2.5 |
| ADSL | Enterprise | 7,100,000 | 1,100,000 | 772,126 | 119,625 | 0.4 | 2.6 |
| ADSL | Max-speed | 8,000,000 | 3,000,000 | 870,000 | 326,250 | 0.3 | 0.9 |
| FTTH | Case-study (Palo Alto) | 7,100,000 | 4,400,000 | 887,600 | 660,000 | 0.3 | 0.6 |
| CATV | Max-speed | 10,000,000 | 10,000,000 | 1,250,000 | 1,250,000 | 0.2 | 0.2 |

1. A method for synchronously transferring an amount of local data from a local data storage medium to a remote data storage medium via a communications link having an available bandwidth, the local data storage medium associated with a local computer system having a local processor sequentially responsive to a plurality of local computer programs, the remote data storage medium associated with a remote computer system non-redundant of the local computer system and having a remote processor, the method comprising:
evaluating local user conditions associated with transfer of the local data;
based on the available bandwidth and the amount of local data, approximating a transfer time for the local data;
based on the approximated transfer time, the local user conditions, and a status of the local processor, selecting a time to transmit the local data to the remote data storage medium; and
automatically arranging transfer of the local data to the remote data storage medium via the communications link at the selected time.

2. A computer-readable medium encoded with a computer program which, when loaded into a processor, implements the method of claim 1.

3. The computer-readable medium according to claim 2, wherein the computer program comprises one of the plurality of local computer programs, and the processor comprises the local processor.

4. The computer-readable medium according to claim 2, wherein the processor comprises the remote processor.

5. The method according to claim 1, further comprising: automatically transmitting the local data to the remote data storage medium at the selected time.

6. The method according to claim 1, further comprising: automatically arranging for interruption of transfer of the local data based on the status of the local processor.

7. The method according to claim 6, further comprising: automatically interrupting transfer of the local data based on the status of the local processor.

8. The method according to claim 6, wherein the status of the local processor is inferred from one of: a status of a display device; a status of a memory; a configured processor utilization; and a time since a last interactive use of the local computer system.

9. The method according to claim 8, wherein the status of the display device comprises activation of a screen-saver.

10. The method according to claim 6, further comprising: after automatically arranging for interruption of transfer of the local data, automatically arranging for resumption of transfer of the local data based on the status of the local processor.

11. The method according to claim 10, further comprising: automatically resuming transfer of the local data based on the status of the local processor.

12. The method according to claim 1, wherein the local user conditions comprise one of: a location of the local data; a preferred transfer time; a file extension associated with the local data; and a status of the communication link.

13. The method according to claim 1, wherein the remote processor and the local processor are under independent control.

14. An apparatus for synchronously transferring an amount of local data from a local data storage medium to a remote data storage medium via a communications link having an available bandwidth, the local data storage medium associated with a local computer system having a local processor sequentially responsive to a plurality of local computer programs, the remote data storage medium associated with a remote computer system non-redundant of the local computer system and having a remote processor, the apparatus comprising:
a computer-readable storage medium; and
a processor responsive to the computer-readable storage medium and to a computer program, the computer program, when loaded into the processor, operative to perform a method comprising:
evaluating local user conditions associated with transfer of the local data;
based on the available bandwidth and the amount of local data, approximating a transfer time for the local data;
based on the approximated transfer time, the local user conditions, and a status of the local processor, selecting a time to transmit the local data to the remote data storage medium; and
automatically arranging transfer of the local data to the remote data storage medium via the communications link at the selected time.

15. A method for managing transfer of data from a source data storage medium associated with a source computer system to a repository data storage medium associated with a repository computer system, the source computer system arranged to receive online requests for the data from a local computer system, and the repository computer system arranged to provide an online data storage service for the local computer system, the method comprising:
receiving a request from the local computer system for transfer of the data from the source data storage medium to the repository data storage medium;
based on the request, determining an authorization status of the local computer system to access the data, the authorization status based on whether an operator of the local computer system is licensed under predetermined intellectual property rights associated with the data; and
based on the authorization status, arranging for transfer of the data from the source data storage medium to the repository data storage medium,
the continued accessibility of the local computer system to the data in the repository data storage medium based on the authorization status of the local computer system.

16. A computer-readable medium encoded with a computer program which, when loaded into a processor, implements the method of claim 15.

17. The method according to claim 15, further comprising: transmitting the data from the source data storage medium to the repository data storage medium.

18. The method according to claim 15, further comprising: sending the request by the local computer system to one of the source computer system and the repository computer system.

19. The method according to claim 15, wherein the source data storage medium is associated with an audio/visual content provider.

20. The method according to claim 19, further comprising: if the local computer system is not licensed, automatically offering to license the operator prior to transferring the data.

21. The method according to claim 20, further comprising: charging a fee to the operator for the license.

22. The method according to claim 21, wherein the fee is based on an intended use of the data by the operator.

23. A system for managing transfer of data from a source data storage medium to a repository data storage medium, the repository data storage medium arranged to provide an online data storage service for a local computer system, the system comprising:
a network communications interface;
a source coupled to the network communications interface, for receiving a request from the local computer system for transfer of the data from the source data storage medium to the repository data storage medium, and for arranging for determination of an authorization status of the local computer system to access the data, the authorization status based on whether an operator of the local computer system is licensed under predetermined intellectual property rights associated with the data; and
an information processing system for processing the request received by the source, and for arranging transfer of the data from the source data storage medium to the repository data storage medium,
the continued accessibility of the local computer system to the data in the repository data storage medium based on the authorization status of the local computer system.
